(19) United States
(12) Patent Application Publication
(10) Pub. No.: US 2026/0038899 A1
(43) Pub. Date: Feb. 5, 2026

(54) METHOD FOR RECYCLING RECHARGEABLE BATTERIES AND RECHARGEABLE BATTERY PROCESSING SYSTEM

(71) Applicant: DUESENFELD GMBH, Wendeburg (DE)

(72) Inventor: Till BUSSMANN, Burgwedel (DE)

(21) Appl. No.: 18/710,902

(22) PCT Filed: Apr. 27, 2022
(86) PCT No.: PCT/EP2022/061280

§ 371 Date: Sep. 3, 2025

(30) Foreign Application Priority Data
Dec. 14, 2021 (EP) 21214491.9

(51) Int. Cl. H01M 10/54; C22B 1/248; C22B 3/02; C22B 7/00

(52) U.S. Cl. CPC H01M 10/54; C22B 1/248; C22B 3/02; C22B 7/006

(57) ABSTRACT

The invention relates to a method for recycling rechargeable batteries, especially lithium rechargeable batteries and/or sodium rechargeable batteries containing a conducting salt dissolved in a conducting salt solvent, comprising the steps: (a) short-circuiting the rechargeable batteries until at least 75% of the galvanic elements have a regeneration cell voltage of at most 0.3 volts, particularly at most 0.2 volts, and (b) subsequently comminuting the rechargeable batteries, thereby obtaining comminuted material.

The invention relates to a method for recycling rechargeable batteries, in particular lithium rechargeable batteries or sodium rechargeable batteries, which contain a conducting salt dissolved in a conducting salt solvent, the rechargeable batteries preferably consisting of at least one galvanic element, each of which has two poles.

According to a second aspect, the invention relates to a rechargeable battery processing system, in particular a lithium rechargeable battery processing system, with (a) a rechargeable battery comminution system for comminuting the rechargeable batteries, thus obtaining comminuted material, and (b) a washing device for washing the comminuted material with a washing solvent, thus obtaining washing liquid.

Rechargeable batteries that cannot be reused should be recycled. In the recycling process, substances or chemical elements in the rechargeable batteries are separated from each other such that they can be reused to manufacture rechargeable batteries or for other purposes.

It is desirable for recycling to produce as few unwanted by-products as possible. In particular, it is desirable to minimize greenhouse gas emissions during recycling, as one of the reasons for the increased use of rechargeable batteries is the desire to reduce the amount of greenhouse gases produced during energy supply.

A wide range of methods are known for recycling rechargeable batteries, especially lithium rechargeable batteries; however, their carbon footprint is comparatively large.

Above all, it is desirable to recycle as many rechargeable battery components as possible so that they can be reused to manufacture rechargeable batteries. This has proven difficult.

The invention is based on the task of improving the recycling of rechargeable batteries, especially lithium rechargeable batteries.

The invention solves the problem by way of a method for recycling rechargeable batteries, in particular lithium rechargeable batteries and/or sodium rechargeable batteries consisting of at least one galvanic element, each of which has two poles, and containing a conducting salt dissolved in a conducting salt solvent, comprising the steps (a) short-circuiting the rechargeable batteries until at least 75% of the galvanic elements have a regeneration cell voltage of at most 0.4 volts, particularly at most 0.3 volts, preferably at most 0.2 volts, particularly at most 0.15 volts, and (b) subsequently comminuting the rechargeable batteries, thereby obtaining comminuted material. Preferably, said method comprises the steps (a) comminuting the rechargeable batteries, thereby obtaining comminuted material, and (b) washing the conducting salt out of the comminuted material using a washing solvent, thereby obtaining washed comminuted material.

The invention also solves the problem by way of a method for recycling rechargeable batteries, especially lithium batteries, which contain a conducting salt dissolved in a conducting salt solvent, comprising the steps (a) comminuting the rechargeable batteries, thereby obtaining comminuted material, and (b) washing the conducting salt out of the comminuted material using a washing solvent, thereby obtaining washed comminuted material. Said method preferably comprises the steps of (a) short-circuiting the rechargeable batteries until at least 75% of the galvanic elements have a regeneration cell voltage of at most 0.2 volts, particularly at most 0.15 volts, and (b) subsequently comminuting the rechargeable batteries, thereby obtaining comminuted material.

Advantageous designs described in the following relate to both inventions.

According to a second aspect, the invention solves the problem by way of a rechargeable battery reprocessing system according to the preamble comprising a washing device for washing the comminuted material with a washing solvent, thereby obtaining washing liquid.

Short-circuiting the rechargeable batteries means that the conducting salt can be recovered with a particularly high degree of purity. Why short-circuiting increases the purity of recovered conducting salt has not been fully clarified. Presumably, a regeneration cell voltage that is considerably greater than 0 V causes heat to develop locally during comminution, which may facilitate the decomposition of conducting salt and/or the formation of hydrogen fluoride.

It should be noted that deep discharging alone does not lead to a regeneration cell voltage of at most 0.2 V. Deep discharging is understood to mean draining the current of the rechargeable battery until its capacity is almost completely exhausted, particularly to below the end-point voltage. The energy content of the rechargeable battery is very low following deep discharging: on the one hand, the cell voltage has reduced dramatically and on the other, the discharge current that can be achieved is very small. Methods from the prior art therefore only encompass deep discharging.

However, it has been proven that the energy content following deep discharging is high enough to be able to cause the formation of hydrogen fluoride. The quantities of hydrogen fluoride that form during comminution of deeply discharged, but not short-circuited rechargeable batteries, are indeed comparatively small, but it has been shown that even low levels of contamination of the conducting salt with decomposition products can negatively impact the suitability of the conducting salt and/or the electrolyte for the production of new rechargeable batteries.

Regeneration cell voltage refers to the cell voltage acting on the respective galvanic element after a given regeneration time, during which the poles of the rechargeable battery are not electrically connected. The characteristic that the poles of the rechargeable battery are not electrically connected is understood to mean that the poles are insulated from each other, i.e. there is a resistance of at least 1 megohm between the two poles. In other words, no electrical energy is drained from the galvanic element during the regeneration time. In particular, the poles of the galvanic elements of the rechargeable battery are electrically unconnected during the regeneration time.

The cell voltage increases during the regeneration time. Even discharging a rechargeable battery to a cell voltage of less than 0.2 V, for example, leads to a regeneration cell voltage of more than 0.2 V if discharging is not carried out for long enough.

It has been determined that a rechargeable battery INR18650-25R from Samsung, made in February 2022, has a cell voltage of 0 V following 1 hour of short-circuiting. The regeneration cell voltage was 1 V. After 3 hours of short-circuiting the cell voltage was 0 V and the regeneration cell voltage was 0.8 V. After 5 hours of short-circuiting the cell voltage was 0 V and the regeneration cell voltage was 0.6 V. After 24 hours of short-circuiting the cell voltage was 0 V and the regeneration cell voltage was 0.2 V

Short-circuiting the rechargeable batteries until the regeneration cell voltage is at most 0.4 V, in particular at most 0.3 V, in particular at most 0.2 V, can also be referred to as regeneration-safe short-circuiting. It is therefore beneficial to not short-circuit the rechargeable batteries until after regeneration-safe short-circuiting of the rechargeable batteries.

It can be determined whether regeneration-safe short-circuiting has taken place by storing the corresponding rechargeable battery for the regeneration time without an external electrical load and in particular without a short-circuit at 1013 hPa and 23° C. In other words, the rechargeable batteries can also be short-circuited until at least 75% of the galvanic elements have the specified maximum regeneration cell voltage if the rechargeable batteries are comminuted or otherwise processed before the regeneration time has elapsed. The only decisive factor is whether they are short-circuited so that the specified regeneration cell voltage would not be exceeded after the regeneration time has elapsed.

The regeneration time is 12 hours. It should be noted that this is not a statement of how long the rechargeable batteries are short-circuited. In particular, short-circuiting the rechargeable batteries for 12 hours may still lead to a regeneration cell voltage above 0.2 volts.

Preferably, the rechargeable batteries are short-circuited for a short-circuiting time of at least 8 hours, particularly at least 10 hours, preferably at least 12 hours, especially at least 15 hours, particularly at least 18 hours. It is especially beneficial if the short-circuiting time is at least 20 hours, for example 24 hours. The short-circuiting time is preferably less than 120 hours. This renders it possible—as is intended according to one preferred embodiment—to ensure that at least 90 percent by weight, in particular at least 95 percent by weight, of the conducting salt of the rechargeable battery does not decompose during comminution.

It is beneficial if short-circuiting is performed using a metallic conductor. In the process, the metallic conductor connects the poles of the rechargeable battery, i.e. the negative pole and the positive pole, load free. This means that the metallic conductor does not connect the poles of the rechargeable battery with an electrical resistance or another electrical consumer. It is especially beneficial if the connection of negative and positive pole does not occur by means of a liquid, in particular a salt solution.

Preferably, an electrical resistance between the positive pole of the rechargeable battery and a negative pole of the rechargeable battery during short-circuiting is at most 10 ohms, in particular at most 1 ohm, preferably at most 0.3 ohms.

It is possible, but not essential, to transport the rechargeable battery following regeneration-safe short-circuiting, particularly over a distance of at least 1 km, particularly at least 5 km. The regeneration-safe short-circuiting minimizes the risk of fire and thus the environmental hazard posed by the rechargeable battery. Preferably, the rechargeable battery is not transported over a distance of more than 1 km following regeneration-safe short-circuiting, since such transport may pose a safety risk.

The method preferably comprises the step of drying the comminuted material at a temperature of at most 80° C., in particular at most 70° C., especially preferably at most 60° C., for example at most 50° C., and at a pressure of at most 300 hPa, in particular at most 50 hPa, thereby obtaining comminuted material.

Preferably the drying causes at least 40 percent by weight, in particular at least 50 percent by weight, preferably 60 percent by weight, especially preferably at least 70 percent by weight, of the solvent of the electrolyte to be removed. Preferably at most 95 percent by weight of the solvent of the electrolyte is removed, in particular at most 90 percent by weight, especially preferably at most 85 percent by weight. Washing out the conducting salt with the washing solvent leads to the method having a higher carbon footprint, so that it is favorable to remove only the part of the electrolyte solvent that cannot be removed more effectively by drying.

It is beneficial to wash the conducting salt out of the comminuted material dried in this manner using a washing solvent.

The black mass is preferably separated prior to washing out the conducting salt and the conducting salt washed out of the black mass. The separation of the black mass preferably occurs after drying.

Separation is understood to mean a process in which the black mass is separated from other components of the comminuted material. The separation of heavy material and/or films from the comminuted material, in particular dried comminuted material, is a separation of the black mass.

It may be beneficial to short-circuit the rechargeable batteries during comminution. This results in a particularly low-level loss of conducting salt.

The advantage of the invention is that washing out the conducting salt means that a large part of fluorine can be removed from the comminuted material, insofar as the rechargeable battery contains fluorine. Fluorine can react to form hydrogen fluoride and/or fluoroorganic substances, which are highly toxic and/or lead to major wear on the rechargeable battery reprocessing system.

To be able to reuse the conducting salt and/or the conducting salt solvent to produce rechargeable batteries without time-consuming cleaning, it must be of high purity. It has been found that this is difficult to achieve simply by short-circuiting the rechargeable batteries and simply by washing out the conductive salt with the washing solvent and/or drying at a maximum of 80° C. under vacuum. However, particularly pure conducting salt and/or conducting salt solvent can be obtained by combining the two methods.

If at least lithium rechargeable batteries are also processed, washing out the conducting salt enables a large part of the lithium to be removed relatively easily. This facilitates any subsequent wet chemical extraction.

If the conducting salt solvent contains a component with a boiling point that is higher than the boiling point of the washing solvent, which represents a preferred embodiment of the invention, washing out the conducting salt generally means that this component can also largely be removed. In a subsequent drying step, which is provided according to a preferred embodiment, said component no longer needs to be removed or only needs to be removed to a lesser extent, which facilitates drying.

Within the scope of the present description, a lithium rechargeable battery refers to a rechargeable battery in which the electrical useful energy is provided by an electrochemical reaction with lithium. The lithium rechargeable battery contains an electrolyte, which is the conducting salt solvent.

The comminuted material is understood to mean the product from comminuting the rechargeable batteries. The comminuted material can be altered by further mechanical separation steps or split into different fractions. Following a chemical conversion, i.e. a chemical reaction, for example burning or adding an acid, which is not only carried out to adjust the pH value, there is no longer any comminuted material.

Washing out refers in particular to adding and removing the washing solvent from the comminuted material so that conducting salt passes into the washing solvent. The washing out may comprise a continuous adding and removal of the washing solvent-one then refers to continuous washing out. The washing out may also comprise a one-time adding and one-time removal of the washing solvent-one then refers to discontinuous washing out. The washing out may also comprise multiple, but not continuous, adding and removal of the washing solvent-one then refers to semi-continuous washing out. When washing out or washing is referred to in the following, it always refers to adding and removing the washing solvent.

The washing solvent is preferably an organic solvent. Preferably, the washing solvent is a pure substance, i.e. not a mixture. The characteristic that the washing solvent is a pure substance is understood in particular to mean that the washing solvent consists of at least 85 percent by weight, in particular at least 90 percent by weight, of a pure substance. However, a mixture of pure substances can also be used. A mixture preferably contains at most three components.

For example, the washing solvent is acetone, acetoacetic ester, ethyl acetate, methyl ethyl ketone and/or tetrahydrofuran. The washing solvent preferably does not contain N-methyl-2-pyrrolidone.

The washing solvent can also be a supercritical fluid, for example supercritical carbon dioxide, or a gaseous fluid at 1013 hPa and 30° C., for example liquid carbon dioxide. This results in an especially high degree of purity of the recovered conducting salt and/or recovered solvent of the electrolyte.

The black mass is understood to mean the fraction of the comminuted material containing graphite that is obtained from the comminuted material by separating housing parts and metal parts, for example connection electrodes, as well as foils, for example the separator foil or conductor foil parts.

Foils are understood particularly to mean parts of the separator foil and conductor foil.

According to one preferred embodiment, the conducting salt is a fluorine compound and/or contains at least 5 percent by weight of a fluorine compound. This fluorine compound is preferably LiPF6 or NaPF6. In this case, it is favorable to wash the conducting salt out until the quantity of it (measured as weight) has decreased by at least 80%, especially at least 90%.

Preferably, the conducting salt contains a lithium compound or at least 50 percent by weight of a lithium compound. By removing the conducting salt, it is then preferable to remove a large proportion, especially at least half, of all the lithium in the comminuted material. It is therefore easier to remove the conducting salt and thus the lithium from the washing solvent than from the comminuted material.

Preferably, the conducting salt contains a chlorine compound or at least 50-percent by weight of a chlorine compound. The conducting salt is preferably a boron compound, such as sodium tetraborate, or contains at least 50—by weight of a boron compound. Such conducting salts are particularly sensitive to local temperature increases, which may occur when rechargeable batteries are not short-circuited for long enough.

Washing out is preferably carried out until at least 80% ethylene carbonate (EC), dimethyl carbonate (DMC), ethyl methyl carbonate (EMC) and/or diethyl carbonate (DEC) have been removed. Alternatively or additionally, washing out is preferably carried out until at least 80% fluorobenzene, methanol, ethanol, propylene carbonate, phenylcyclohexane (cyclohexylbenzene) and/or trimethyl-(trifluoromethyl)-silane have been removed.

The method preferably comprises the step of removing the washing solvent from the comminuted material. The washing solvent can be removed, for example, by vacuuming, wiping, spinning or draining.

Preferably, the method comprises the step of separating the washing solvent from a washing liquid, which has been obtained by washing the conducting salt out of the comminuted material using the washing solvent. This results in regenerated washing solvent. In this way, the washing solvent can be reused, as is intended according to a preferred embodiment, meaning that it can be added back into the comminuted material. The washing solvent is preferably recirculated, i.e. used again and again.

The washing solvent is separated from the washing liquid by distillation, for example, especially continuous distillation. Alternatively or additionally, separation may comprise gravity separation and/or centrifuging and/or filtering.

It is beneficial if the method comprises the step of wet chemical extraction of at least one metallic component from the comminuted material. The wet chemical extraction preferably includes the step of adding a mineral acid, especially sulphuric acid or hydrochloric acid.

The wet chemical extraction preferably includes the step of adding concentrated sulphuric acid, so that at least 80%, particularly at least 90%, of the remaining fluorine is removed. Washing out the conducting salt beforehand means that less sulphuric acid has to be used to remove the fluorine. This leads to less waste and lower consumption of resources.

The conducting salt solvent has a maximum boiling point. This is the temperature at which at least 99 percent by weight of 1 liter of conducting salt solvent has evaporated after 1 hour at this temperature at 1013 hPa. If the conducting salt solvent is composed of a pure material, as is intended according to a preferred embodiment, the maximum boiling point corresponds to the boiling point of the conducting salt solvent. If, as is intended according to an alternative embodiment, the conducting salt solvent is a mixture of pure materials that each have a boiling point, the maximum boiling point of the highest-boiling component.

Preferably, the maximum boiling point of the washing solvent is below the maximum boiling point of the conducting salt solvent. The maximum boiling point of the washing solvent is preferably at least 10 Kelvin, preferably at least 20 Kelvin, especially preferably at least 30 Kelvin below the maximum boiling point of the conducting salt solvent.

It is favorable if the maximum boiling point of the washing solvent is at most 90° C., preferably at most 80° C., especially preferably at most 70° C., particularly at most 60° C. and particularly preferably at most 50° C. This facilitates the removal of the washing solvent in a subsequent drying step that preferably takes place. In addition, drying at such low temperatures reduces or prevents the formation of hazardous fluorine compounds, especially hydrogen fluoride.

The conducting salt has a solubility in the washing solvent that is given in grams of conducting salt per liter of washing solvent at the maximum saturation of the washing solvent with conducting salt. According to one preferred embodiment, a solubility of the conducting salt in the washing solvent is at least half the solubility of the conducting salt in electrolytes. It is particularly beneficial if the solubility of the conducting salt in the washing solvent is greater than in the conducting salt solvent.

Preferably, the conducting salt is washed out by means of explosion-proof machines and/or in an explosion-proof atmosphere.

Preferably, the washing solvent is a solvent for PVDF (polyvinylidene fluoride). PVDF is a frequently used binding agent in lithium batteries and contains fluorine. A suitable washing solvent can also dissolve out the binder, which further reduces the fluorine concentration in the washed, comminuted material.

Preferably, the washing out of the conducting salt also constitutes a dissolving of the binding agent. According to one preferred embodiment, washing with the washing solvent is carried out until at least 70 percent by weight, preferably at least 80 percent by weight, especially at least 90 percent by weight of the binding agent has been removed.

The method preferably comprises the steps (a) drying the washed comminuted material and preferably (b) subsequently separating foils, especially metal foils and/or heavy material from the washed comminuted material, thereby obtaining black mass.

Alternatively, the method may comprise the steps (a) separating foils, especially metal foils, and/or heavy material from the washed comminuted material and (b) subsequently drying the washed comminuted material.

Drying is preferably performed at a negative pressure. For example, the pressure during drying is at most 700 hPa, especially at most 600 hPa, preferably at most 500 hPa. In particular, the pressure is at least 100 hPa, preferably at least 200 hPa, especially at least 300 hPa. The temperature during drying is preferably at most 90° C., preferably at most 80° C., especially preferably at most 70° C., particularly at most 60° C. and particularly preferably at most 50° C.

According to one preferred embodiment, the drying finishes when so much washing solvent has been removed that a flammable atmosphere cannot develop at 23° C. and 1013 hPa in a 50 l container half-filled with dried material.

If metal foils are separated, according to one preferred embodiment they are also dried after washing and/or black mass adhering to the metal foil is separated, for example by means of an air jet sieve.

The method preferably comprises the step of drying the comminuted material following comminution, in particular without any previous washing. Drying is preferably carried out at at most 80° C., especially at most 70° C., preferably at most 60°, especially preferably at most 50°. This results in dried comminuted material.

Drying is preferably performed at a negative pressure, the pressure preferably being at most 600 hPa, particularly at most 300 hPa.

Drying is preferably carried out in such a way that high-boiling components whose vapor pressure at 50° C. is below 10 hPa, in particular below 5 hPa, are removed to a maximum of 30 percent by weight, in particular a maximum of 20 percent by weight. The further removal of these components requires significant effort in terms of time and energy. By subsequently washing the comminuted material, the high-boiling components are washed out and thus removed.

Alternatively or additionally, the drying stops before the conducting salt solvent has been removed by more than 95 percent by weight, in particular more than 90 percent by weight. As a result, components of the electrolytes that are especially difficult to remove remain in the comminuted material. Said components can then be simply washed out in a step of washing the conducting salt out of the comminuted material using the washing solvent, which is provided for according to a preferred embodiment.

In the dried comminuted material, heavy material, in particular comminuted parts of the housing, and/or foils, in particular metal foils, are separated in a step provided for in a preferred embodiment. Comminuted material in the form of black mass is obtained as a result.

Separating heavy material, which consists in particular of plastic parts of the housing, prevents these objects from being dissolved by the washing solvent during any subsequent washing. This would result in contamination of the washing solvent.

According to one preferred embodiment, the method comprises the step of separating the foils into plastic foils and metal foils from the comminuted material, which may have been dried. The metal foils are often coated with black mass. The black mass often does not detach completely from the metal foil. Conversely, the plastic foil is generally not coated with black mass, but can be dissolved or swollen by the washing solvent, which is usually undesirable. By separating the foils into plastic foils and metal foils, which is done mechanically for example, both foil types can be processed separately.

Preferably, the metal foils are washed with the washing solvent after being separated from the plastic foils. This can be done with the separated black mass or separately from it. If the metal foil, as is provided for by a preferred embodiment, is not washed out prior to separation from the plastic foil (not even together with other foils), the metal foil is preferably washed out with black mass not adhering to the metal foil. Alternatively or additionally, the metal foil is washed out separately. The latter has the advantage that a black mass with a particularly high cobalt content is obtained for most types of lithium batteries during washing.

This black mass is a form of comminuted material. According to a preferred embodiment, the conducting salt is washed out of this comminuted material using the washing solvent.

Preferably, the black mass obtained in this way is then dried. Drying is preferably carried out at at most 70° C., preferably at most 60°, especially preferably at most 50°. This results in dried comminuted material. Drying is preferably performed at a negative pressure, the pressure preferably being at most 600 hPa, particularly at most 300 hPa.

However, it is also possible to conduct drying at more than 80°. This may cause fluorine compounds to form, such as hydrogen fluoride. However, the prior washing out of the conducting salt reduces the amount of hydrogen fluoride produced.

A rechargeable battery processing system according to the invention preferably has a washing solvent regeneration system for separating washing solvent from the washing liquid and returning the washing solvent to the washing device. The washing solvent regeneration system includes, for example, a distillation device.

Preferably, the rechargeable battery processing system has a dryer arranged either downstream or upstream of the washing device in the direction of material flow, said dryer being designed to dry the dried comminuted material. In particular, the dryer is arranged immediately downstream or upstream of the washing device, i.e. the dryer is directly connected to the washing device. This connection is preferably dust-tight, in particular gas-tight.

According to one preferred embodiment, the rechargeable battery processing system has a separating device for separating heavy material and/or foils, especially plastic and/or metal foils, of the comminuted material, thereby obtaining black mass. Said separating device can be arranged upstream or downstream of the washing device in the direction of material flow. It is also possible that the rechargeable battery processing system has two separating devices, one being arranged upstream of the washing device and one being arranged downstream of the washing device in the direction of material flow.

It is possible, but not essential, for the separating device to form part of the washing device or to share a housing with the washing device. However, the separating device is preferably arranged separately from the washing device.

The rechargeable battery processing system preferably has a wet chemical processing system for the wet chemical extraction of at least one metal component from the washed black mass. The wet chemical processing system preferably has at least one reactor, which is designed to add a mineral acid, in particular concentrated sulphuric acid, to the washed black mass. To this end, the reactor has a feed for sulphuric acid and a sulphuric acid container, preferably filled with sulphuric acid.

The processing system preferably has an exhaust gas purification system for purifying the exhaust gas produced when adding concentrated sulphuric acid to the washed black mass. For example, the exhaust gas cleaning system comprises a hydrogen fluoride precipitator to precipitate hydrogen fluoride. For this purpose, a liquid can be used which, for example, contains calcium ions.

The rechargeable battery processing system is preferably designed to be explosion-proof. If, as is provided for in a preferred embodiment, a solvent is used that has a flash point below 250° C., there may be a risk of explosion if no protective measures are taken. Therefore, particularly the lines leading away from the washing device 22 are preferably designed to be explosion-proof. Particularly preferably, all lines in the path of material flow between the rechargeable battery comminution system and a dryer are designed to be explosion-proof.

In the following, the invention will be explained in more detail with the aid of the accompanying drawing. They show:

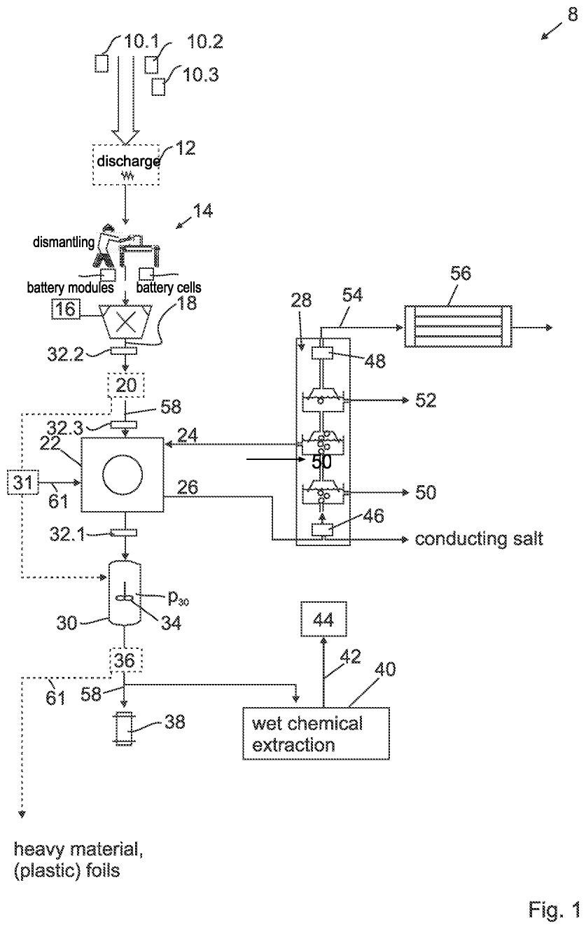

FIG. 1 a schematic view of a rechargeable battery processing system according to the invention for carrying out a method according to the invention according to a first embodiment,

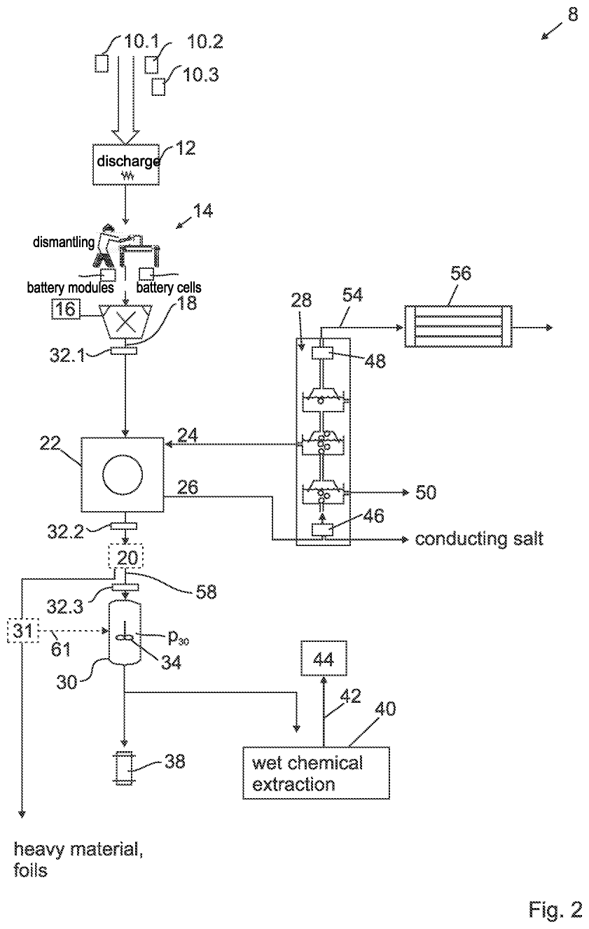

FIG. 2 a schematic view of a rechargeable battery processing system according to the invention for carrying out a method according to the invention according to a second embodiment,

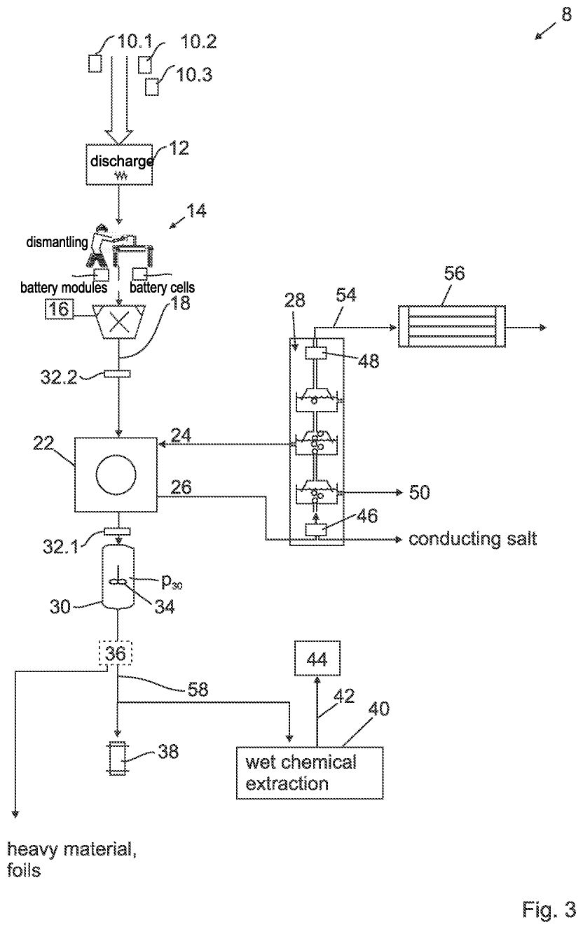

FIG. 3 a schematic view of a rechargeable battery processing system according to the invention for carrying out a method according to the invention according to a third embodiment,

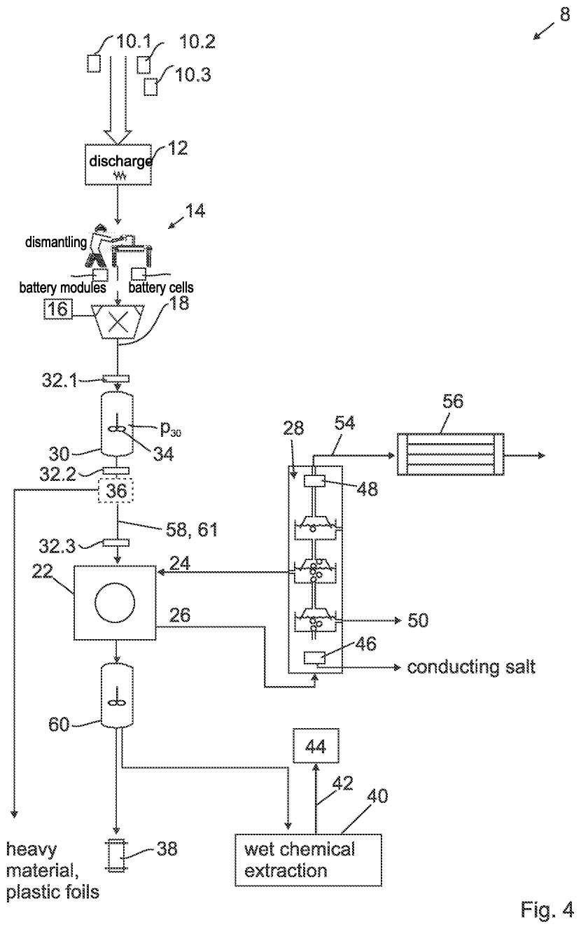

FIG. 4 a schematic view of a rechargeable battery processing system according to the invention for carrying out a method according to the invention according to a fourth embodiment,

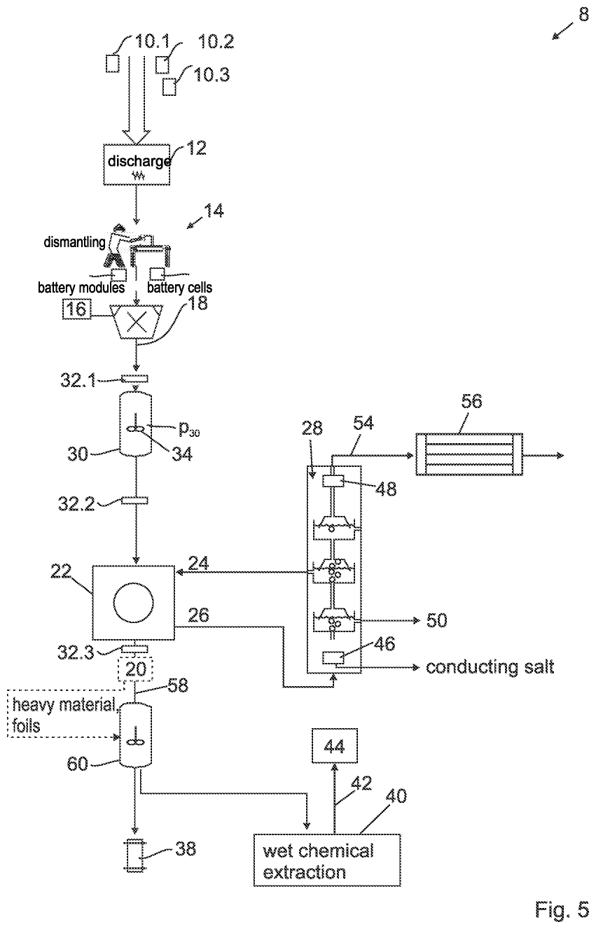

FIG. 5 a schematic view of a rechargeable battery processing system according to the invention for carrying out a method according to the invention according to a fifth embodiment,

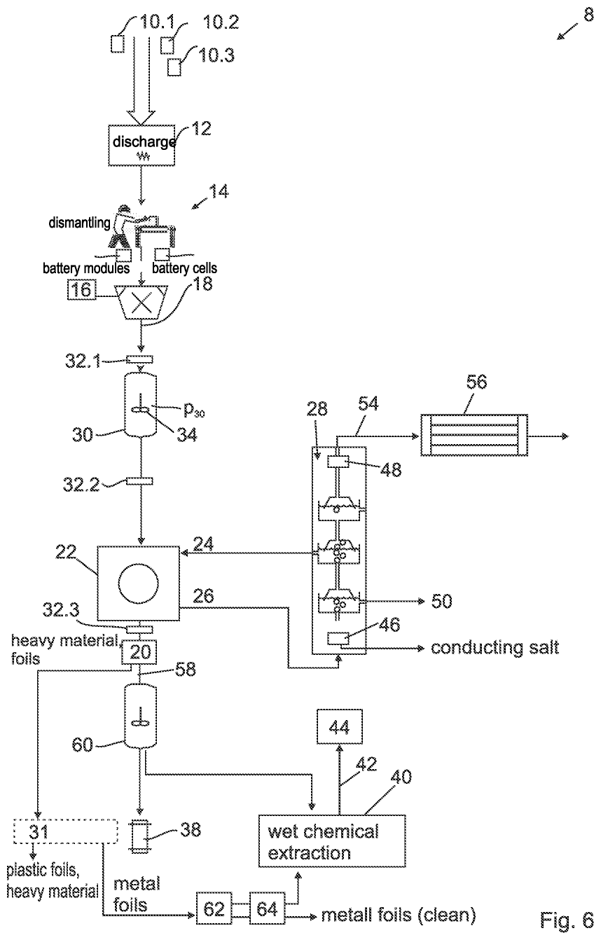

FIG. 6 a schematic view of a rechargeable battery processing system according to the invention for carrying out a method according to the invention according to a sixth embodiment, and

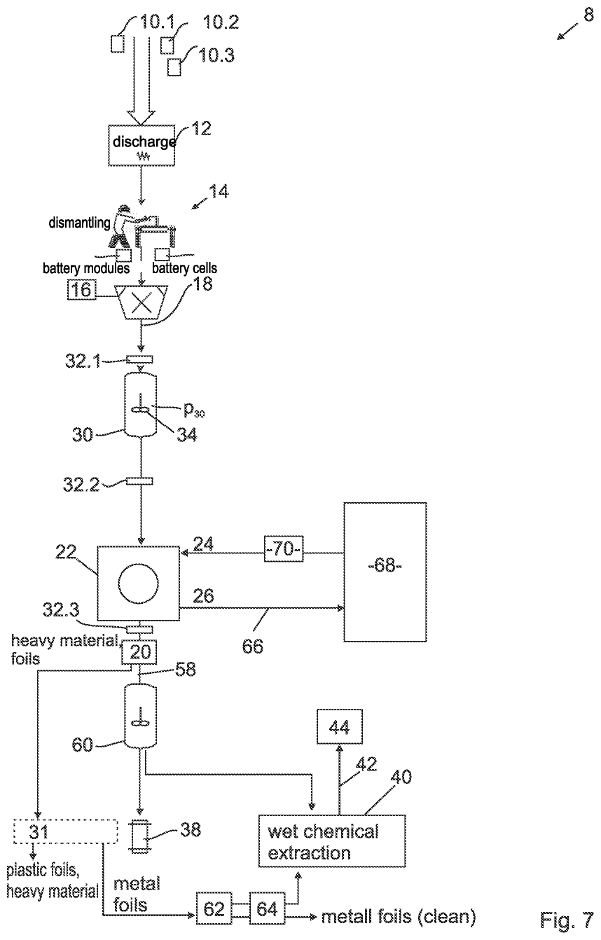

FIG. 7 a schematic view of a rechargeable battery processing system according to the invention for carrying out a method according to the invention according to a seventh embodiment.

FIG. 1 shows a rechargeable battery processing system 8 for processing rechargeable batteries 10.1, 10.2, . . . . The rechargeable batteries may be in the form of battery systems, for example, each of which contains a number of galvanic cells and a charge control.

The rechargeable batteries are first subjected to a deep discharge in a discharge station 12. A voltage between the electrodes of the rechargeable batteries is then smaller than 0.1 V, for example.

After deep discharging, the rechargeable batteries 10.1, 10.2, . . . are short-circuited by means of a metal wire, preferably a copper wire. The copper wire has a resistance of 1 ohm, for example. A short-circuit time Tₖ, for which the rechargeable batteries 10.1, 10.2, . . . are short-circuited, is Tₖ=20 hours in the present case. This results in a regeneration cell voltage U_{reg} of U_{reg}=0.2 V.

After charging, the individual battery cells are removed from the battery system in an optional dismantling station 14.

The rechargeable battery processing system 8 has a rechargeable battery comminution system 16 for comminuting the rechargeable batteries 10.1, 10.2, . . . , thereby obtaining comminuted material 18. For example, the rechargeable battery comminution system 16 is designed to to cut, crush or grind the rechargeable batteries 10.1, 10.2, . . . .

An optional separating device 20 (depicted by the dashed line, as with all optional components) may be arranged downstream of the rechargeable battery comminution system 16 in the direction of material flow. The separating device 20 is used to separate the comminuted material 18 into black mass 58 and a residual fraction. The residual fraction contains housing parts, usually comminuted plastic parts, as well as metal parts, for example connection electrodes, and films, for example the separator film or conductor film parts. In the case of lithium rechargeable batteries, the black mass 58 contains graphite, substances deposited in the graphite, such as metal salts, conducting salt solvent and conducting salt. If a separating device 20 is provided, it is preferably connected to the rechargeable battery comminution system 16 via a dust-tight line, in particular an airtight line.

A washing device 22 is arranged downstream of the rechargeable battery comminution system 16 and, if present, downstream of the separating device 20 in the direction of material flow. The washing device 22 may also be referred to as a washer. In the washing device 22, the comminuted material is dissolved with a washing solvent 24. It is advantageous, but not essential, for the washing device 22 to comprise a mixer, such as an agitator, or a rotatably mounted drum.

Due to the contact with the comminuted material 18 the washing solvent 24 becomes a washing liquid 26. The washing liquid 26 contains conducting salt and is regenerated by an optional washing solvent regeneration system 28 and fed back into the washing device 22.

If the separating device 20 is present, an optional foil separator 31 may be provided, by means of which metal foils 61 are separated from the residual fraction. The metal foils 61 obtained in this way can also be fed to the washing device 22.

A dryer 30 is arranged downstream of the washing device 22 in the direction of material flow, the latter serving to dry the washed comminuted material, in particular the washed black mass 58. The dryer 30 is separated from the washing device 22 by an airlock 32.1. The components not separated by the foil separator 31 are dried in the dryer 30 or a further dryer. If the components not separated by the foil separator 31 are dried in the dryer 30, it preferably occurs at a time offset to the black mass 58.

An airlock 32.2 may also be arranged between the rechargeable battery comminution system 16 and the washing device 22. If a separating device 20 is provided, an airlock 32.3 may also be arranged between the separating device 20 and the washing device 22.

The dryer 30 has an optional mixer 34, for example a rod mixer. It is possible that the mixer 34, in particular an agitator element of the mixer, is cooled or heated.

A pressure p₃₀ in the dryer 30 is preferably p₃₀≤700 hPa, particularly p₃₀≤600 hPa. A temperature T₃₀ in the dryer is preferably at most 70° C., particularly at most 50° C.

If no separating device 20 is provided, the dried comminuted material can be separated into black mass on the one hand and a residual fraction on the other in an optional separating device 36 arranged downstream of the dryer 30 in the direction of material flow. The residual fraction consists, for example, of heavy material and metal foils. The rechargeable battery processing device 8 generally only has one separating device 20, 36.

If the separating device is provided and the metal foils are fed to the washing device 22, the dried comminuted material can be separated in the optional separating device 36 into black mass and the purified metal foils.

The dried comminuted material, in particular the dried black mass 58, is either filled in a transport container 38 or fed to a wet chemical processing system 40. In the processing system 40, the metal components of the black mass 58 (in the form of metal salts) are dissolved. To this end, the black mass is mixed, for example, with a mineral acid, in particular concentrated sulphuric acid, and leached, in particular with water. Resulting exhaust gas 42 is fed to an exhaust gas purification system 44 where, for example, hydrogen fluoride is removed, for example precipitated.

The washing solvent regeneration system 28 includes, for example, a distillation line. First, the washing liquid 26 is converted into a gaseous state, for example by means of a heater 46 or by applying a negative pressure by means of a vacuum pump 48. The resulting gaseous components are condensed in fractions.

The fraction whose boiling point corresponds to the boiling point of the washing solvent 24 is fed back into the washing device 22.

Higher-boiling components 50 and lower-boiling components 52 are further processed, for example re-distilled. The components of the electrolytes of the rechargeable batteries 10 can thus be recycled. Non-condensed components 54, which are primarily air, are purified in an exhaust gas purification system 56 and released into the surrounding environment. Higher-boiling components 50 are the components whose boiling point is higher than the maximum boiling point of the washing solvent.

The washing solvent regeneration system 28 is, however, not essential. Alternatively, the washing solvent 24 can be fed from a storage container to the washing device 22 and the washing liquid 26 likewise directed into a storage container. Any processing of the washing liquid 26 can then be carried out in a washing solvent regeneration system located elsewhere.

FIG. 2 shows an alternative embodiment of a rechargeable battery processing system 8 according to the invention. The washing device 22 is arranged immediately downstream of the rechargeable battery comminution system 16 in the direction of material flow. This should be understood to mean that no relevant treatment of the comminuted material 18 takes place downstream of the rechargeable battery comminution system 16 and upstream of the washing device 22 in the direction of material flow. Comminuted material 18 is conveyed into the washing device 22 by means of a dust-tight, in particular a gas-tight and/or explosion-proof, line and via the optional airlock 32.2.

After the comminuted material 18 is washed, black mass 58 is separated from the washed comminuted material in the separating device 20 and likewise reaches the dryer 30 via a dust-tight, in particular a gas-tight and/or explosion-proof, line. Heavy material and foils are obtained in addition to the black mass 58. Heavy material and foils can be dried in another dryer or, if the dryer 30 is operated discontinuously, in the dryer 30.

It is favorable if metal foils 61 are separated from the heavy material and the foils in an optional foil separator 31. The metal foils 61 can be dried in the dryer 30 or another dryer. If the metal foils 61 are dried in the dryer 30, it can be carried out together with the black mass 58 or at a time offset.

The pressure p₃₀ in the dryer 30 arranged downstream of the washing device 22 in the direction of material flow is preferably below the vapor pressure of the washing solvent 24 at 60° C., in particular 50° C., which constitutes a preferred characteristic regardless of the other characteristics described in relation with the figure. The dried black mass 58 can either be filled in the transport container 38 or directly fed to a wet chemical processing system 40.

FIG. 3 shows a third embodiment of a rechargeable battery processing system 8 according to the invention. The washing device 22 is again arranged immediately downstream of the rechargeable battery comminution system 16 in the direction of material flow. The washed comminuted material ends up in the dryer 30. The black mass 58 is separated from the dried comminuted material in the optional separating device 36 arranged immediately downstream of the dryer 30. The fraction separated from the black mass 58 is processed as described above in relation to FIG. 2.

FIG. 4 depicts a fourth embodiment of a rechargeable battery processing system 8 according to the invention, in which the comminuted material 18 coming from the rechargeable battery comminution system 16 is immediately directed into the dryer 30.

After drying, the black mass 58 is separated in the separating device 36 and washed in the washing device 22. The washed black mass is dried in a second dryer 60.

It is beneficial if the metal foils 61 are separated in the separating device 36 and also introduced into the washing device 22. The metal foils 61 and the black mass 58 can be washed together or one after the other in terms of time. As another alternative, the metal foils 61 can be washed in a separate washing device. If the metal foils 61 and the black mass 58 are washed together, they are preferably separated from each other afterwards.

If the metal foils 61 are washed separately from the black mass, the rechargeable battery processing system 8 preferably has a separator, which removes the black mass 58′ adhering to the metal foil 61.

If the metal foil 61 and the black mass 68 are washed together and dried in the dryer 60, the rechargeable battery processing system 8 preferably has a separating device for separating the metal foil 61 and the black mass 58 as well as a separator that removes the black mass 58′ adhering to the metal foil 61.

According to one preferred embodiment, it is also possible to wash the heavy material and/or the plastic foils in the washing device 22 or a further washing device. The heavy material and/or the foils can be dried in the dryer 60 and/or a separate dryer.

The final pressure p₃₀, end in the dryer 30, i.e. the pressure at the end of the drying process, is preferably p₃₀≤300 hPa, in particular p₃₀≤50 hPa. A temperature T₃₀ in the dryer is preferably at most 60° C., particularly at most 50° C.

FIG. 5 shows a fifth embodiment of a rechargeable battery processing system 8 according to the invention, in which the separating device 20 is arranged immediately downstream of the washing device 22 in the direction of material flow. The separated heavy material and the foils are dried in the dryer 60 at a time offset to the black mass 58. Alternatively, the separating device 20 may also be arranged downstream of the second dryer 60 in the direction of material flow.

FIG. 6 shows a further embodiment of a rechargeable battery processing system 8 according to the invention, in which, after the washing device 22, the separating device 20 separates the black mass 58 on the one hand and the residual fraction, which comprises the heavy material and the films, on the other hand. The foil separator 31 is arranged downstream of the separating device 20 in the direction of material flow, the foil separator extracting the metal foils and feeding them to a separate dryer 62. The black mass 58 adhering to the metal foil often contains more cobalt than non-adhering black mass 58. As an alternative to the separate dryer 62, the metal foil can also be dried in the dryer 60. A separator 64, such as an air jet sieve, is arranged downstream of the dryer 60 in the direction of material flow for separating the black mass from the dried metal foils.

FIG. 7 schematically depicts a further embodiment of the rechargeable battery processing system 8 according to the invention, in which washing solvent 24 is used as supercritical carbon dioxide. This can be understood both as a liquid and as a gas. The washing solvent is drawn off via a pressure line 66 and vaporized in an evaporator 68. The gaseous carbon dioxide is converted to the supercritical state by a high-pressure pump 70 and returns to the washing device 22.

### REFERENCE LIST

8 rechargeable battery processing system
10 rechargeable batteries
12 discharge station
14 dismantling station
16 rechargeable battery comminution system
18 comminuted material
20 separating device
22 washing device
24 washing solvent
26 washing liquid
28 washing solvent regeneration system
30 dryer
31 foil separator
32 airlock
34 mixer
36 separating device
38 transport container
40 wet chemical processing system
42 exhaust gas
44 exhaust gas purification system
46 heater
48 vacuum pump
50 higher-boiling components
52 lower-boiling components
54 non-condensed components
56 exhaust gas purification unit
58 black mass
60 dryer
62 dryer
64 separator
66 pressure line
68 evaporator
70 high-pressure pump
Tₖ short-circuit time
U_{reg} regeneration cell voltage

1. A method for recycling rechargeable batteries, in particular lithium rechargeable batteries and/or sodium rechargeable batteries, consisting of at least one galvanic element, each of which has two poles, and containing a conducting salt dissolved in a conducting salt solvent, comprising the steps
(a) short-circuiting the rechargeable batteries until at least 75% of the galvanic elements have a regeneration cell voltage of at most 0.3 volts, particularly at most 0.2 volts, and
(b) subsequently comminuting the rechargeable batteries, thereby obtaining comminuted material.

2. The method according to claim 1, wherein the short-circuiting
(a) is performed with a metallic conductor and/or
(b) is performed in such a way that, during short-circuiting, an electrical resistance between a negative pole of the rechargeable battery and a positive pole of the rechargeable battery is at most 1 W, in particular at most 0.3 W.

3. The method according to claim 1, further comprising
(a) drying the comminuted material at a temperature of at most 80° C. and a pressure of at most 300 hPa, thereby obtaining dried comminuted material and
(b) subsequently washing the conducting salt out of the dried comminuted material using a washing solvent, thereby obtaining washed comminuted material.

4. The method according to claim 3, further comprising:
(a) separating black mass before washing out the conducting salt, in particular after drying, and
(b) washing the conducting salt out of the black mass.

5. The method according to claim 1, wherein the rechargeable batteries are short-circuited during comminution.

6. A method for recycling rechargeable batteries, especially lithium rechargeable batteries and/or sodium rechargeable batteries containing a conducting salt dissolved in a conducting salt solvent, comprising the steps:
(a) comminuting the rechargeable batteries, thereby obtaining comminuted material, and
(b) washing the conducting salt out of the comminuted material using a washing solvent, thereby obtaining washed comminuted material.

7. The method according to claim 1, wherein
(a) the conducting salt is a fluorine compound and/or
(b) a lithium compound.

8. The method according to claim 1, further comprising:
(a) separating the washing solvent from a washing liquid, which has been obtained by washing the conducting salt out of the comminuted material using the washing solvent, in particularly by way of distillation, thereby obtaining regenerated washing solvent, and
(b) reusing the regenerated washing solvent to wash out conducting salt.

9. The method according to claim 8, further comprising:
separating the conducting salt from the washing solvent, particularly by way of distillation.

10. The method according to claim 1, further comprising
wet chemical extraction of at least one metallic components from the washed comminuted material.

11. The method according to claim 1, wherein
(a) the conducting salt solvent has a maximum boiling point, the maximum boiling point being the temperature at which at least 99 percent by weight of 1 liter of conducting salt solvent has evaporated after 1 hour at this temperature at 1013, and
(b) the washing solvent has a maximum boiling point below the maximum boiling point of the conducting salt solvent.

12. The method according to claim 1, wherein the washing solvent is a solvent for PVDF.

13. The method according to claim 1, further comprising
(a) drying the washed comminuted material and subsequently
(b) separating foils, especially metal foils, from the washed comminuted material.

14. The method according to claim 1, further comprising:
(a) after comminuting the rechargeable batteries, drying the comminuted material, thereby obtaining dried comminuted material,
(b) optionally separating heavy material and/or foils, especially plastic foils, from the dried comminuted material, thereby obtaining black mass, and
(c) washing the conducting salt out of the dried comminuted material, particularly in the form of black mass, using the washing solvent,
(d) drying the black mass.

15. A rechargeable battery processing system comprising
(a) a rechargeable battery comminution system for comminuting the rechargeable batteries, thereby obtaining comminuted material, and
(b) a washing device for washing the comminuted material with a washing solvent, thereby obtaining washing liquid.

16. The rechargeable battery processing system according to claim 0, wherein
a washing solvent regeneration system for separating washing solvent from the washing liquid and returning the washing solvent to the washing device.

17. The rechargeable battery processing system according to claim 0, wherein the washing solvent regeneration system comprises a distillation device.

18. The rechargeable battery processing system according to claim 15, wherein
at least one dryer arranged either downstream and/or upstream of the washing device in the direction of material flow, said dryer being designed to dry the dried comminuted material.

19. The rechargeable battery processing system according to claim 15, further comprising
a separating device for separating heavy material and/or foils, in particular metal foils and/or plastic foils, of the comminuted material, thereby obtaining black mass.

20. The rechargeable battery processing system according to claim 15, wherein
a wet chemical processing system for the wet chemical extraction of at least one metal component from the washed black mass.
